(19) United States
(12) Patent Application Publication
(10) Pub. No.: US 2015/0012850 A1
(43) Pub. Date: Jan. 8, 2015

(54) MOBILE DEVICE INCLUDING A FLEXIBLE DISPLAY DEVICE

(71) Applicant: SAMSUNG DISPLAY CO., LTD., Yongin-City (KR)

(72) Inventors: SEONG-MIN WANG, Suwon-si (KR); Ja-Eun Lee, Yongin-City (KR); Mu-Gyeom Kim, Yongin-City (KR)

(73) Assignee: SAMSUNG DISPLAY CO., LTD., Yongin-City (KR)

(21) Appl. No.: 14/208,708

(22) Filed: Mar. 13, 2014

(30) Foreign Application Priority Data
Jul. 4, 2013 (KR) 10-2013-0078483

(51) Int. Cl. G06F 3/0481; G06F 3/0482; G06F 1/16; G06F 3/0486

(52) U.S. Cl. CPC G06F 3/04817; G06F 3/0486; G06F 3/0482; G06F 1/1652
USPC 715/761

(57) ABSTRACT

A mobile device including a flexible display device includes a main display unit disposed on the front of the mobile device, a upper secondary display unit disposed on an upper side of the main display unit, a lower secondary display unit disposed on a lower side of the main display unit, a left secondary display unit disposed on a left side of the main display unit, a right secondary display unit disposed on a right side of the main display unit, and a control unit configured to control the flexible display device to change an icon when the icon displayed on one of the upper, lower, left and right secondary display units passes a border of the one of the upper, lower, left and right secondary display units.

### CROSS-REFERENCE TO RELATED APPLICATION(S)

This application claims priority under 35 USC §119 to Korean Patent Applications No. 10-2013-0078483, filed on Jul. 4, 2013 in the Korean Intellectual Property Office (KIPO), the disclosure of which is incorporated by reference in its entirety herein.

### BACKGROUND

1. Technical Field

Exemplary embodiments of the inventive concept relate to mobile devices. More particularly, exemplary embodiments of the inventive concept relate to mobile devices including flexible display devices.

2. Discussion of Related Art

A flexible display device can be bent by using a flexible substrate or film made of a bendable material such as a plastic. Such a flexible display device has properties of thinness, lightness, and impact resistance as well as flexibility, which may result in an infinite amount of applications in the future. Various shapes or forms of mobile devices employing such flexible display devices have been recently researched and developed. However, the user interfaces for current flexible display device are inconvenient. Thus, there is a need for more convenient user interfaces for the flexible display devices.

### SUMMARY

At least one exemplary embodiment of the inventive concept provides a mobile device that includes a plurality of display units to perform various moving effects of an icon.

At least one exemplary embodiment of the inventive concept provides a mobile device that includes a plurality of display units including at least two display units respectively located at the front side and the back side of the mobile device using at least two flexible display panels.

According to an exemplary embodiment of the inventive concept, a mobile device including a flexible display device includes a main display unit disposed on a front of the mobile device (e.g., along a plane), an upper secondary display unit disposed on an upper side of the main display unit, the upper secondary display unit inclining at a first predetermined angle with respect to a plane extending from the main display unit, a lower secondary display unit disposed on a lower side of the main display unit, the lower secondary display unit inclining at a second predetermined angle with respect to the plane extending from the main display unit, a left secondary display unit disposed on a left side of the main display unit, the left secondary display unit inclining at a third predetermined angle with respect to the plane extending from the main display unit, a right secondary display unit disposed on a right side of the main display unit, the right secondary display unit inclining at a fourth predetermined angle with respect to the plane extending from the main display unit, and a control unit configured to control the flexible display device to change an icon (e.g., at least one of a speed, a size, and a shape of the icon) when the icon displayed on one of the upper, lower, left, and right secondary display units passes a border of the one of the upper, lower, left, and right secondary display units.

In exemplary embodiments, the main display unit and the upper, lower, left, and right secondary display units may be integrally formed as one cross-shaped display panel.

In exemplary embodiments, the first through fourth predetermined angles between the plane extending from the main display unit and the upper, lower, left, and right secondary display units may be acute angles.

In exemplary embodiments, at least one of the upper, lower, left, and right secondary display units may be deactivated by a user setting.

In exemplary embodiments, the control unit may perform one of a move command, a copy command, a deletion command, and a run command for the icon depending on a direction in which the icon moves.

In exemplary embodiments, when the icon displayed on the one of the upper, lower, left, and right secondary display units is moved to another one of the upper, lower, left, and right secondary display units by a drag and drop operation, the control unit may perform one of a move command and a copy command for the icon.

In exemplary embodiments, when the icon displayed on the one of the upper, lower, left, and right secondary display units is moved out of the flexible display device by a drag and drop operation, the control unit may perform a deletion command for the icon.

In exemplary embodiments, when the icon displayed on the one of the upper, lower, left, and right secondary display units moves to the main display unit, the control unit may perform a run command for the icon to execute an application corresponding to the icon and to display an execution screen of the application at the main display unit, and when the execution screen of the application moves to one of the upper, lower, left, and right secondary display units, the control unit may terminate the executed application.

In exemplary embodiments, at least one of the main display unit, the upper secondary display unit, the lower secondary display unit, the left secondary display unit, and the right secondary display unit may include a curved display region having a curved shape.

In exemplary embodiments, while the icon moves on the curved display region, at least one of the speed, the size, and the shape of the icon may change according to the curved shape of the curved display region.

According to an exemplary embodiment of the inventive concept, a mobile device including a flexible display device includes a first main display unit disposed on a front of the mobile device (e.g., along a first plane), a upper secondary display unit disposed on an upper side of the first main display unit, the upper secondary display unit inclining at a first predetermined angle with respect to a plane extending from the first main display unit, a lower secondary display unit disposed on a lower side of the first main display unit, the lower secondary display unit inclining at a second predetermined angle with respect to the plane extending from the first main display unit, a second main display unit disposed on a back of the mobile device (e.g., along a second plane), a left secondary display unit disposed on a left side of the second main display unit, the left secondary display unit inclining at a third predetermined angle with respect to a plane extending from the second main display unit, a right secondary display unit disposed on a right side of the second main display unit, the right secondary display unit inclining at a fourth predetermined angle with respect to the plane extending from the second main display unit, and a control unit configured to control the flexible display device to change an icon (e.g., at least one of a speed, a size, and a shape of the icon) when the icon displayed on one of the upper, lower, left, and right secondary display units passes a border of the one of the upper, lower, left, and right secondary display units.

In exemplary embodiments, the first main display unit, the upper secondary display unit, and the lower secondary display unit may be integrally formed as a first display panel and the second main display unit, the left secondary display unit and the right secondary display unit may be integrally formed as a second display panel.

In exemplary embodiments, the first and second predetermined angles between the plane extending from the first main display unit and the upper and lower secondary display units may be acute angles.

In exemplary embodiments, the third and fourth predetermined angles between the plane extending from the second main display unit and the left and right secondary display units may be obtuse angles.

In exemplary embodiments, at least one of the upper, lower, left and right secondary display units may be deactivated by a user setting.

In exemplary embodiments, at least one of the first and second main display units is deactivated by a user setting.

In exemplary embodiments, at least one of the first main display unit, the second main display unit, the upper secondary display unit, the lower secondary display unit, the left secondary display unit and the right secondary display unit includes a curved display region having a curved shape.

In an exemplary embodiment, while the icon moves on the curved display region, at least one of the speed, the size, and the shape of the icon changes according to the curved shape of the curved display region.

According to an exemplary embodiment of the inventive concept, a mobile device including a flexible display device includes a main display unit disposed at a front of the mobile device along a plane, an upper secondary display unit disposed on an upper side of the main display unit, the upper secondary display unit inclined at a first predetermined angle with respect to the plane, a lower secondary display unit disposed at a lower side of the main display unit, the lower secondary display unit inclined at a second predetermined angle with respect to the plane, a left secondary display unit disposed at a left side of the main display unit, the second secondary display unit inclined at a third predetermined angle with respect to the plane, a right secondary display unit disposed at a right side of the main display unit, the right secondary display unit inclined at a fourth predetermined angle with respect to the plane, and a control unit configured to perform one of a move command and a copy command when an icon is moved from a first one of the secondary display units to another second one of the secondary display units.

The control unit may present a menu on the second one of the secondary display units that enables a user to select between one of the copy command and the move command. The control unit may be configured to change an appearance of the icon when the icon is moved outside the first secondary display unit.

A mobile device according to an exemplary embodiment of the inventive concept may have a three-dimensional structure including not only the main display unit but also the secondary display units, and may provide a user interface that implements a moving effect of the icon, thereby providing a user convenience and a pleasing visual effect. Further, in at least one exemplary embodiment, the mobile device may have a curved display region, which may result in an improvement in gripping the device.

### BRIEF DESCRIPTION OF THE DRAWINGS

The present invention will become more apparent by describing in detail exemplary embodiments thereof with reference to the accompanying drawings, in which:

FIG. 1 is a diagram illustrating a mobile device in accordance with an exemplary embodiment of the inventive concept.

FIG. 2 is a plan view of an exemplary embodiment of a flexible display device included in a mobile device of FIG. 1.

FIG. 3 is a diagram illustrating an exemplary embodiment where a flexible display device is placed on a mobile device of FIG. 1.

FIG. 4 is a diagram illustrating an exemplary embodiment of a state where a secondary display unit is deactivated.

FIG. 5 is a diagram for describing a user interface of a mobile device in accordance with an exemplary embodiment of the inventive concept.

FIG. 6 is a diagram for describing a user interface of a mobile device in accordance with an exemplary embodiment of the inventive concept.

FIG. 7 is a diagram illustrating a mobile device including a curved display region according to an exemplary embodiment of the inventive concept.

FIGS. 8A and 8B are perspective views of display panels of a mobile device in accordance with exemplary embodiments of the inventive concept.

### DETAILED DESCRIPTION

Hereinafter, exemplary embodiments of the invention will be described more fully hereinafter with reference to the accompanying drawings, in which some exemplary embodiments thereof are shown. The present inventive concept may, however, be embodied in many different forms and should not be construed as limited to the exemplary embodiments set forth herein. In the drawings, the sizes and relative sizes of layers and regions may be exaggerated for clarity. Like numerals refer to like elements throughout.

It will be understood that when an element is referred to as being “connected” or “coupled” to another element, it can be directly connected or coupled to the other element or intervening elements may be present. As used herein, the singular forms “a,” “an” and “the” are intended to include the plural forms as well, unless the context clearly indicates otherwise.

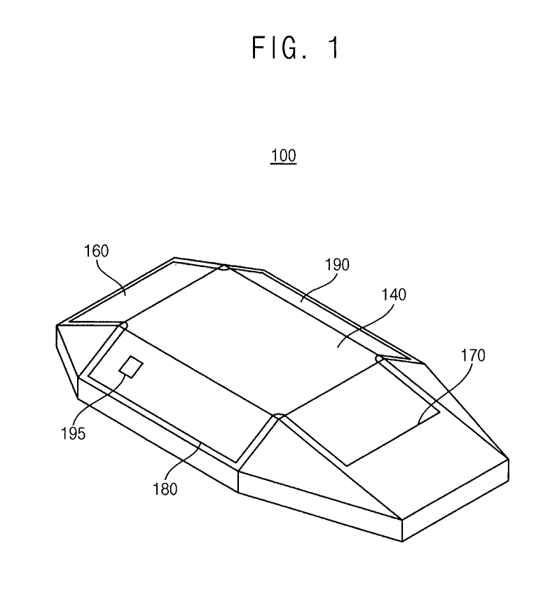

FIG. 1 is a diagram illustrating a mobile device in accordance with an exemplary embodiment of the inventive concept.

Referring to FIG. 1, a mobile device 100 includes a flexible display device having a main display unit 140, at least one secondary display unit 160, 170, 180 and 190 and a control unit.

The flexible display device includes the main display unit 140 disposed on the front of the mobile device 100, an upper secondary display unit 160 disposed on the upper side of the main display unit 140, a lower secondary display unit 170 disposed on the lower side of the main display unit 140, a left secondary display unit 180 disposed on the left side of the main display unit 140, and a right secondary display unit 190 disposed on the right side of the main display unit 140. The upper secondary display unit 160 is inclined at a first predetermined angle with respect to a plane extending from the main display unit 140, the lower secondary display unit 170 is inclined at a second predetermined angle with respect to the plane extending from the main display unit 140, the left secondary display unit 180 is inclined at a third predetermined angle with respect to the plane extending from the main display unit 140, and the right secondary display unit 190 is inclined at a fourth predetermined angle with respect to the plane extending from the main display unit 140. For example, the angles of the planes of the display units 140-190 may differ from one another.

The flexible display device may further include the control unit that controls the flexible display device. The control unit may control the flexible display device to change at least one of a speed, a size, a shape, or a resolution of an icon 195 when the icon 195 displayed at one of the upper, lower, left, and right secondary display units 160, 170, 180, and 190 passes a border of the one of the upper, lower, left, and right secondary display units 160, 170, 180, and 190. For example, the control unit may change the appearance of the icon when it is moved outside one of the secondary display unit to another one of the secondary display units. In an exemplary embodiment, the control unit is a processor. In another exemplary embodiment the control unit is a computer program that is executed by a processor of the mobile device. The control unit may also be implemented partially by a processor and partially by a computer program.

The main display unit 140 may display an execution screen of an application, an icon of an application, etc.

In an exemplary embodiment of the inventive concept, the main display unit 140, the upper secondary display unit 160, the lower secondary display unit 170, the left secondary display unit 180, and the right secondary display unit 190 are integrally formed as one cross-shaped display panel. The main display unit 140 and the upper, lower, left, and right secondary display units 160, 170, 180, and 190 may be distinguished from one another based on a border or a line where the display panel is bent. In an exemplary embodiment of the inventive concept, the main display unit 140, the upper secondary display unit 160, the lower secondary display unit 170, the left secondary display unit 180, and the right secondary display unit 190 are formed separately from each other.

In an exemplary embodiment of the inventive concept, the first through fourth predetermined angles between the plane extending from the main display unit and the upper, lower, left, and right secondary display units are acute angles.

The mobile device 100 may further include, but is not limited to, a memory device, an application processor, etc. In an exemplary embodiment, the control unit is the application processor. The memory device may include at least one volatile memory device such as a dynamic random access memory (DRAM) device, a static random access memory (SRAM) device, a mobile dynamic random access memory (mobile DRAM) device, etc. and/or at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc. The application processor may perform various computing functions or tasks. The application processor may be, for example, a mobile system-on-chip (SOC), a microprocessor, a central processing unit (CPU), etc. The application processor may control other components of the mobile device 100 via a bus.

The secondary display units 160, 170, 180, and 190 may display the icon 195. By manipulating the icon 195 displayed at the secondary display units 160, 170, 180, and 190, a run command, a move command, a copy command and a deletion command for the icon 195 may be performed. While the mobile device 100 operates, at least one secondary display unit 160, 170, 180, and 190 may be deactivated. In an exemplary embodiment, at least one of the upper, lower, left, and right secondary display units 160, 170, 180, and 190 is deactivated by a user setting. For example, when all of the secondary display units 160, 170, 180, and 190 are deactivated by the user setting, only the main display unit 140 displays an image (or an execution screen), and a user may perform a desired action only through the main display unit 140.

The control unit may perform one of the move command, the copy command, the deletion command and the run command for the icon 195 depending on a direction in which the icon 195 moves. For example, when the icon 195 displayed on one of the secondary display units 160, 170, 180, and 190 is moved to another one of the secondary display units 160, 170, 180, and 190 by a drag and drop operation, the move command and/or the copy command for the icon 195 is performed. In an exemplary embodiment, when the icon 195 displayed on one of the secondary display units 160, 170, 180, and 190 is moved out of the flexible display device by a drag and drop operation, the deletion command for the icon 195 is performed. For example, moving the icon 195 out of the upper secondary display unit 160 could mean that the user has attempted to move the icon 195 past its top boundary, moving the icon 195 out of the left secondary display unit 180 could mean that the user has attempted to move the icon 195 past its left boundary, etc.

The control unit may generate a moving effect of the icon 195. The moving effect may correspond to a change of at least one of a speed, a size and a shape of the icon 195. In an exemplary embodiment, the control unit generates the moving effect of the icon 195 when the icon 195 passes the border of one of the secondary display units 160, 170, 180, and 190. The moving effect of the icon 195 may be performed in various forms that are preset in mobile device 100 or are set by a user setting. In an exemplary embodiment, when the icon 195 is dragged from a first one of the secondary display units past a border of a second one of the secondary display units at a first position, the icon 195 automatically moves from the first position to a second position in the secondary display unit.

In an exemplary embodiment, when the icon 195 displayed at one of the upper, lower, left, and right secondary display units 160, 170, 180, and 190 moves to the main display unit 140, the control unit performs a run command for the icon 195 to execute an application corresponding to the icon 195 and to display an execution screen of the application at the main display unit 140. When the execution screen of the application moves to one of the upper, lower, left, and right secondary display units 160, 170, 180, and 190, the control unit may terminate the executed application. For example, when an icon of an internet connecting application displayed at the upper secondary display unit 160 is moved to the main display unit 140 by a drag and drop operation, the internet connecting application is executed, and an execution screen of the internet connecting application is displayed in the main display unit 140. When the execution screen of the internet connecting application displayed at the main display unit 140 is moved to one of the secondary display units 160, 170, 180, and 190 by a drag and drop operation, the internet connecting application is terminated, or switched to a background program (e.g., is run in the background).

In an exemplary embodiment of the inventive concept, at least one of the main display unit 140 and the upper, lower, left, and right secondary display units 160, 170, 180 and 190 is a transparent or light transmission type display unit, and a back side of the flexible display device may be also configured as a transparent type structure.

In an exemplary embodiment of the inventive concept, at least one of the main display unit 140 and the upper, lower, left, and right secondary display units 160, 170, 180, and 190 includes a curved display region having a curved shape. When the icon 195 moves on the curved display region, the control unit may generate the moving effect of the icon 195 according to the curved shape of the curved display region. In an exemplary embodiment the curved display region is wave shaped or is formed in the shape of a waveform. For example, while the icon 195 moves on the curved display region of the waveform, the icon 195 moves slower, and the shape of the icon 195 may be changed according to the waveform. For example, the icon 195 may move at a first speed on a non curved display region and a second speed on the curved display region or the waveform, where the first speed is higher than the second speed.

The mobile device 100 according to an exemplary embodiment of the inventive concept has a three-dimensional structure including not only the main display unit 140 but also the secondary display units 160, 170, 180, and 190, and may provide a user interface that implements the moving effect of the icon 195, thereby providing convenience to a user and a pleasing visual effect. Further, in at least one exemplary embodiment of the inventive concept, the mobile device 100 has a curved display region, which enables the user to more easily grip the device.

Although not illustrated in FIG. 1, in at least one exemplary embodiment of the inventive concept, the mobile device 100 further includes a modem, such as a baseband chipset, for communicating with an external device, a power supply for providing power, at least one input device such as a button, at least one output device such as a speaker, a storage device, such as a memory card, a solid state drive (SSD), etc., a camera image processor, a contact image sensor (CIS), or the like.

The mobile device 100 and/or components of the mobile device 100 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

According to an exemplary embodiment of the inventive concept, the mobile device 100 may be any electronic device including the flexible display device, such as a mobile phone, a smart phone, a laptop computer, a tablet computer, a personal digital assistant (PDA), a portable multimedia player (PMP), a digital camera, a music player, a portable game console, a navigation device, etc.

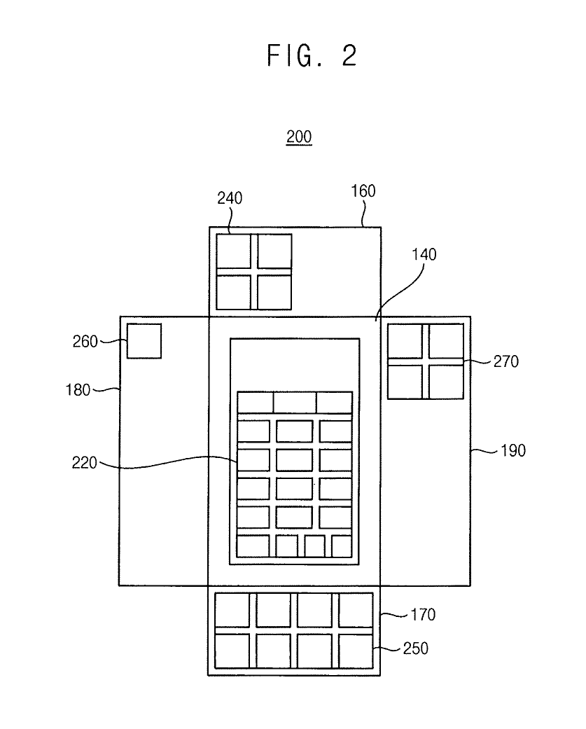

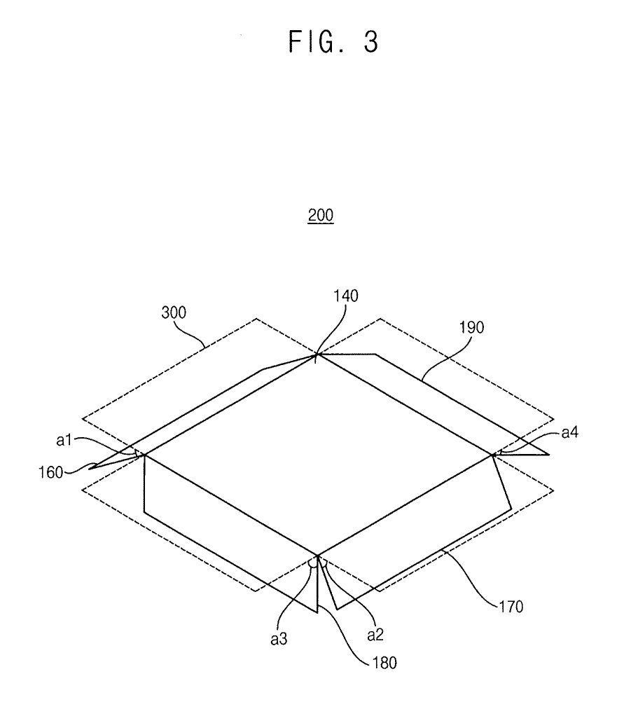

FIG. 2 is a plan view of an exemplary embodiment of a flexible display device included in a mobile device of FIG. 1, and FIG. 3 is a diagram illustrating an embodiment where a flexible display device is placed on a mobile device of FIG. 1.

Referring to FIG. 2, the flexible display device 200 includes a cross-shaped display panel. In an exemplary embodiment, the main display unit 140, the upper secondary display unit 160, the lower secondary display unit 170, the left secondary display unit 180 and the right secondary display unit 190 are integrally formed as one cross-shaped display panel. The upper secondary display unit 160 is disposed on an upper side of the main display unit 140, the lower secondary display unit 170 is disposed on a lower side of the main display unit 140, the left secondary display unit 180 is disposed on a left side of the main display unit 140, and the right secondary display unit 190 is disposed on a right side of the main display unit 140. The main display unit 140 displays an execution screen 220 of a stored application in the mobile device 100. The upper, lower, left, and right secondary display units 160, 170, 180, and 190 display icons 240, 250, 260, and 270 that are stored in the mobile device 100. Please note this configuration of the flexible display device 200 is an example, and the display panel of the flexible display device is not limited thereto.

Referring to FIG. 1 and FIG. 3, the flexible display device 200 is formed by the cross-shaped display panel. The main display unit 140 and the upper, lower, left, and right secondary display units 160, 170, 180, and 190 may be distinguished based on a border or a line where the display panel is bent. The first through the fourth predetermined angles a1, a2, a3, and a4 may be respectively formed by a plane 300 extending from the main display unit 140 with the upper, lower, left, and right secondary display units 160, 170, 180, and 190. Each of the angles a1, a2, a3, and a4 determine the degree of bending of the display panel. The first through fourth predetermined angles a1, a2, a3, and a4 may be acute angles which have the same angle or different angles.

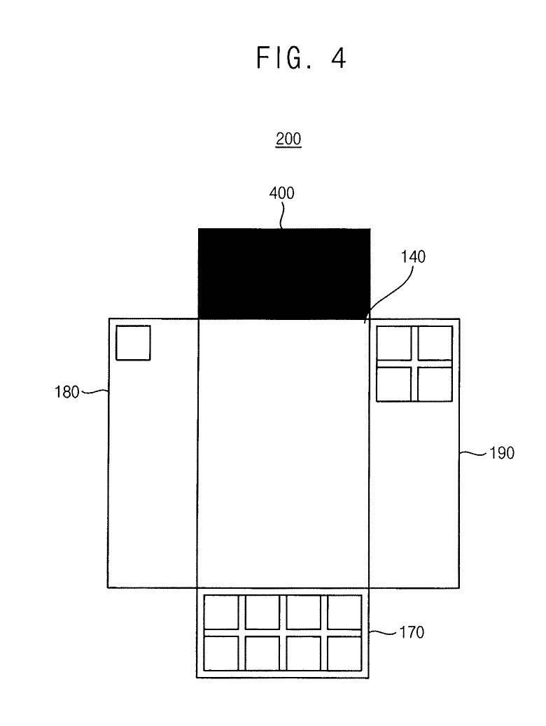

FIG. 4 is a diagram illustrating an example of a state where a secondary display unit is deactivated.

Referring to FIG. 4, in the flexible display device 200 which includes the upper, lower, left, and right secondary display units 160, 170, 180, and 190, at least one of the secondary display units is deactivated selectively by a user setting. For example, when a user deactivates the upper secondary display unit 160, the screen of the upper secondary display unit is deactivated to result in a deactivated screen 400. In an exemplary embodiment, power is not supplied to the deactivated screen 400 of the upper secondary display unit 160, and the deactivated screen 400 does not recognize a user touch. The mobile device may be operated by the remaining activated display units.

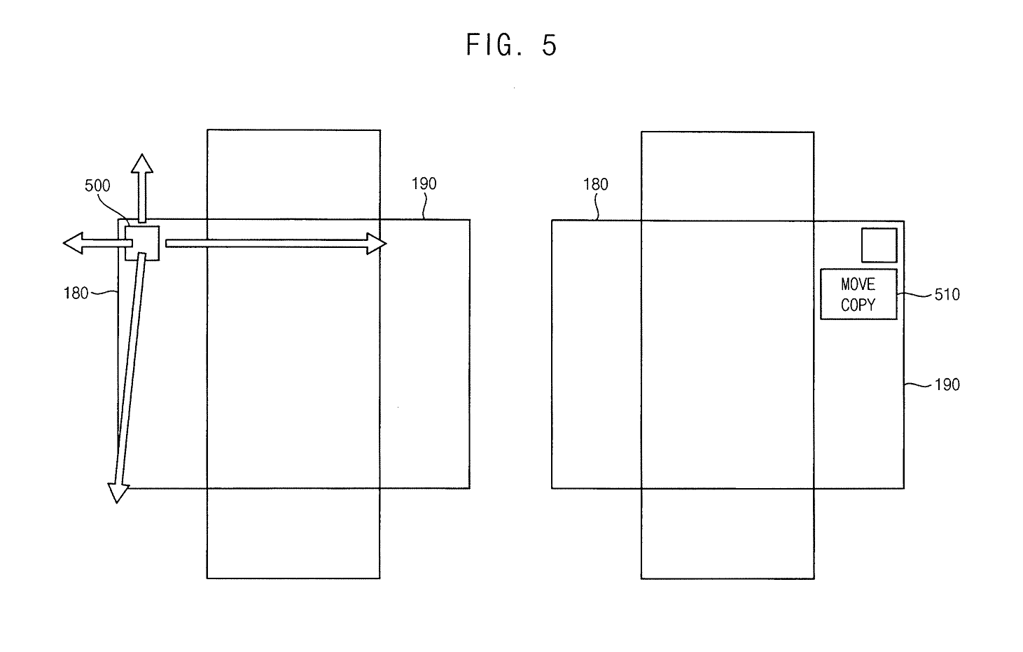

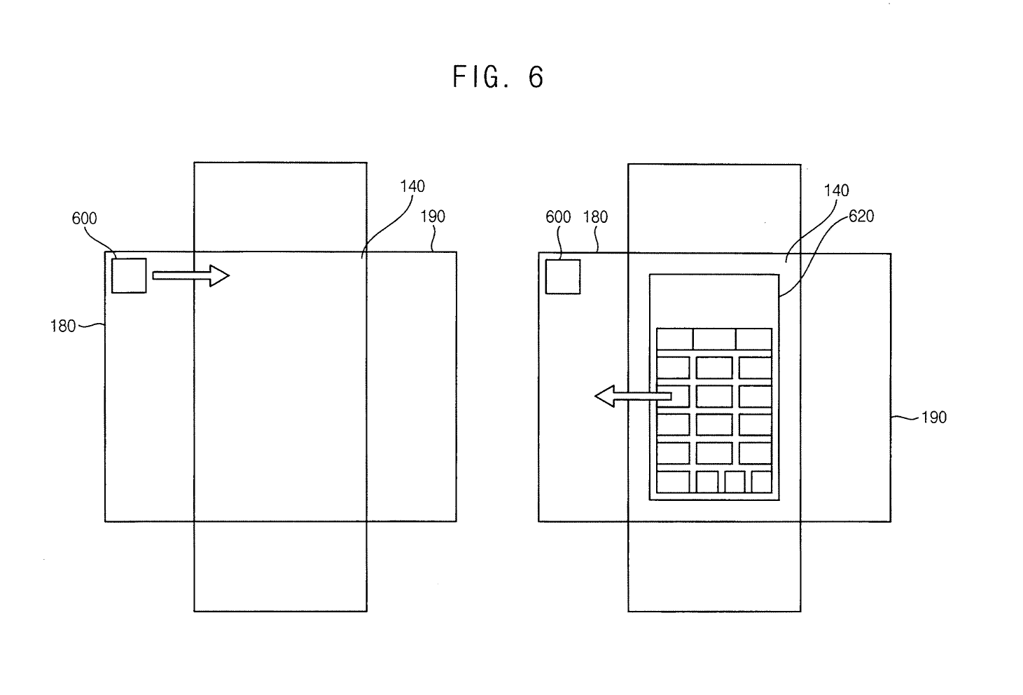

FIG. 5 is a diagram for describing an embodiment of a user interface of the mobile device in accordance with an exemplary embodiment of the inventive concept, and FIG. 6 is a diagram for describing another embodiment of a user interface of the mobile device in accordance with an exemplary embodiment of the inventive concept.

Referring to FIG. 2 and FIG. 5, in an exemplary embodiment, in the mobile device 100 that includes the flexible display device 200 including the main display unit 140 and the upper, lower, left, and right secondary display units 160, 170, 180, and 190, icons 240, 250, 260, and 270 are displayed at the upper, lower, left, and right secondary display units 160, 170, 180, and 190, and the execution screen of an application is displayed on the main display unit 140. In other exemplary embodiments, the icons 240, 250, 260, and 270 and the execution screen of an application may be moved between the display units 140, 160, 170, 180 and 190 by a user. The control unit may generate the moving effect of the icons 240, 250, 260, and 270, while the icons 240, 250, 260, and 270 move. When the icon passes the border of one of the display units 140, 160, 170, 180, and 190, the moving effect of the icons may be performed to change the speed, the shape or the size of the icons and so on. The moving effect may vary based on settings predefined in mobile device or setting applied by the user. For example, when the icon moves from one of the upper, lower, left, and right secondary display units 160, 170, 180, and 190 to the main display unit 140, the shape of the icon may be folded through a curved border, and may be moved slower. For example, a curved border may be added to the moving icon to surround the icon so it can be differentiated from the static icons. However, the inventive concept is not limited thereto, as various visual effects can be applied to the icon while it is being moved.

As illustrated in FIG. 5, in an exemplary embodiment, as an icon 500 displayed on the left secondary display unit 180 is moved to the right secondary display unit 190 by a drag and drop operation, a copy command or a move command of the icon 500 is performed. In an exemplary embodiment, when the icon 500 is moved to the right secondary display unit 190, a confirmation message (or selecting menu) 510 appears on the right secondary display unit 190 to determine whether to move or to copy the icon 500. In this example, if the user selects ‘move’, the icon 500 is moved from the left secondary display unit 180 to the right secondary display unit 190. On the other hand, if the user selects ‘copy’, an icon which is the same as the icon 500 is displayed on the right secondary display unit 190. Since these moves or copies of the icon are examples, the inventive concept is not limited to moving or copying the icon between the secondary display units. For example, the icon may be moved or copied from the main display unit 140 to any secondary display unit, and may be moved or copied from any secondary display unit to the main display unit. In an exemplary embodiment, if a user clicks/touches a cancellation button included in (or displayed on) the mobile device or clicks/touches a particular region (e.g., except the region of the confirmation message 500), the move command and the copy command are canceled.

In an exemplary embodiment, when the icon 500 displayed on one of the secondary display units 160, 170, 180 and 190 is moved out of the flexible display device by a drag and drop operation, the deletion command of the icon 500 is performed.

Referring to FIG. 6, an icon 600 corresponding to a voice call application is displayed on the left secondary display unit 180. In an exemplary embodiment, when a user performs a drag and drop operation of the icon 600 to the main display unit 140, the control unit executes (or activates) the voice call application and the main display unit 140 displays an execution screen of the voice call application 620. In an exemplary embodiment, when a user performs a drag and drop operation of the icon 620 displayed in the main display unit 140 to the left secondary display unit 180, the control unit terminates the voice call application which is running. The control unit may perform terminating (or deactivating) of the running application when the execution screen is moved to the secondary display unit.

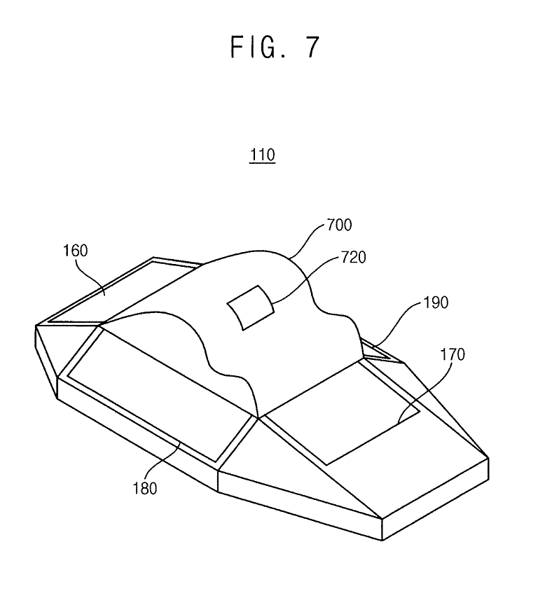

FIG. 7 is a diagram illustrating an exemplary embodiment of a mobile device including a curved display region.

Referring to FIG. 7, in an exemplary embodiment, a mobile device 110 includes a main display unit 700 including a curved display region, the upper, lower, left and right secondary display units 160, 170, 180 and 190, and the control unit. The curved display region 700 may be formed by two or more curvatures. These curved display regions are examples, as the curved display region may be formed in one or more of the other display units (e.g., the second display units), and may include any curvature. Further, the curved display region may include a curved shape that is designed to be in close contact with the user's hands for convenience of gripping the mobile device.

In an exemplary embodiment, when the icon 720 moves along the curved display region, at least one of a speed of the icon, a size of the icon or a shape of the icon displayed on the curved display region changes according to the curved shape of the curved display region. The control unit may control the speed, the shape and the size of icon 720, etc.

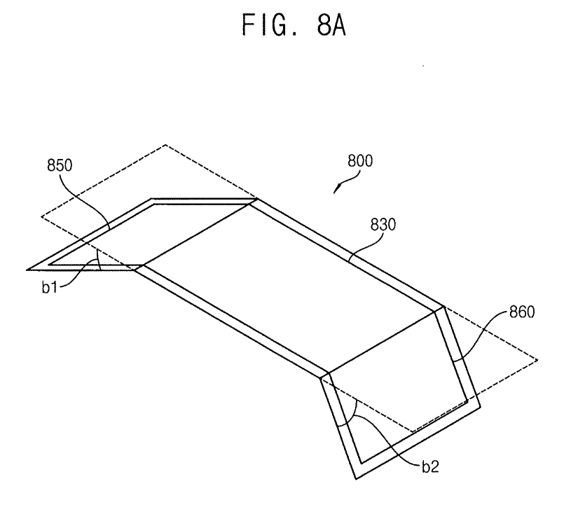

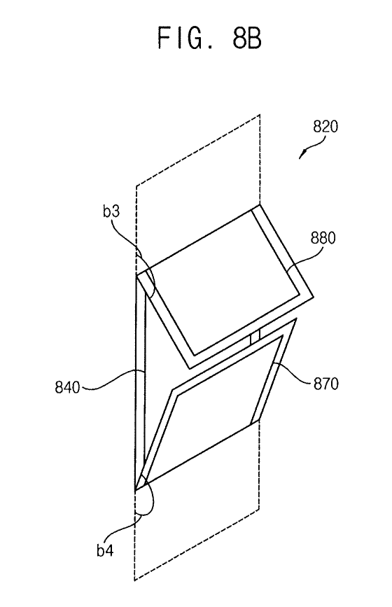

FIGS. 8A and 8B are perspective views of an example of display panels of a mobile device in accordance with exemplary embodiments of the inventive concept.

Referring to FIGS. 8A and 8B, a mobile device includes a flexible display device, and the flexible display device includes a first main display unit 830, a second main display unit 840 and second display units 850, 860, 870 and 880 and a control unit.

The flexible display device includes the first main display unit 830 disposed on the front of the mobile device, the upper secondary display unit 850 disposed on the upper side of the first main display unit 830, the lower secondary display unit 860 disposed on the lower side of the first main display unit 830, the second main display unit 840 disposed on the back of the mobile device, the left secondary display unit 870 disposed on the left side of the second main display unit 840, and the right secondary display unit 880 disposed on the right side of the second main display unit 840. The upper secondary display unit 850 inclines at a first predetermined angle b1 with respect to a plane extending from the first main display unit 830, the lower secondary display unit 860 inclines at a second predetermined angle b2 with respect to the plane extending from the first main display unit 830, the left secondary display unit 870 inclines at a third predetermined angle b3 with respect to the plane extending from the second main display unit 840, and the right secondary display unit 880 inclines at a fourth predetermined angle b4 with respect to the plane extending from the second main display unit 840.

The flexible display device may further include the control unit that controls the flexible display device. The control unit may control the flexible display device to change at least one of a speed, a size, and a shape of an icon when the icon displayed on one of the upper, lower, left and right secondary display units 850, 860, 870, and 880 passes a border of the one of the upper, lower, left and right secondary display units 850, 860, 870, and 880.

In an exemplary embodiment, the flexible display device includes two display panels 800 and 820. In an exemplary embodiment, the first main display unit 830, the upper secondary display unit 850 and the lower secondary display unit 860 are integrally formed as a first display panel 800, and the second main display unit 840, the left secondary display unit 870 and the right secondary display unit 880 are integrally formed as a second display panel 820.

In an exemplary embodiment, the first and second predetermined angles b1 and b2 between the plane extending from the first main display unit 830 and the upper and lower secondary display units 850 and 860 are acute angles. The first and the second predetermined angles b1 and b2 may be the same angle or different angles.

In an exemplary embodiment, the third and fourth predetermined angles b3 and b4 between the plane extending from the second main display unit 840 and the left and right secondary display units 870 and 880 are obtuse angles. The third and the fourth predetermined angles b3 and b4 may be the same angle or different angles.

The secondary display units 850, 860, 870, and 880 may display an icon. By manipulating the icon displayed on the secondary display units 850, 860, 870, and 880, a run command, a move command, a copy command, and a deletion command for the icon may be performed. While the mobile device operates, at least one secondary display unit 850, 860, 870, and 880 may be deactivated. In an exemplary embodiment, at least one of the upper, lower, left and right secondary display units 850, 860, 870, and 880 is deactivated by a user setting. For example, when all of the secondary display units 850, 860, 870 and 880 are deactivated by the user setting, at least one of the first and second main display units 830 and 840 may display an image, and a user may perform a desired action only through one of the first and the second main display units 830 and 840.

The control unit may perform one of the move command, the copy command, the deletion command and the run command for the icon depending on a direction in which the icon moves. In an exemplary embodiment, when the icon displayed on one of the secondary display units 850, 860, 870, and 880 is moved to another secondary display units 850, 860, 870, and 880 by a drag and drop operation, the move command or the copy command for the icon is performed. In an exemplary embodiment, when the icon displayed on one of the secondary display units 850, 860, 870, and 880 is moved out of the flexible display device by a drag and drop operation, the deletion command for the icon is performed.

In an exemplary embodiment, when the icon displayed on one of the secondary display units 850, 860, 870, and 880 moves to one of the first and the second main display units 830 and 840, the control unit may perform a run command for the icon to execute an application corresponding to the icon and to display an execution screen of the application on one of the main display units 830 and 840. When the execution screen of the application moves to one of the upper, lower, left, and right secondary display units 160, 170, 180, and 190, the control unit may terminate the executed application. For example, when an icon of an internet connecting application displayed on the upper secondary display unit 850 is moved to the first main display unit 830 by a drag and drop operation, the internet connecting application is executed, and an execution screen of the internet connecting application is displayed in the first main display unit 830. When the execution screen of the internet connecting application displayed on the first main display unit 830 is moved to one of the secondary display units 850, 860, 870, and 880 by a drag and drop operation, the internet connecting application is terminated, or may be switched to a background program.

The control unit may generate a moving effect of icons. The moving effect may correspond to a change of at least one of a speed, a size and a shape of the icon. In an exemplary embodiment, the control unit generates the moving effect of the icon when the icon passes the border of one of the secondary display units 850, 860, 870, and 880. The moving effect of the icon may be performed in various forms that are preset in the mobile device or are set by a user setting. Since these operations of the control unit are described above, duplicated descriptions will not be repeated.

In an exemplary embodiment, at least one of the first and second main display units 830 and 840, and the upper, lower, left and right secondary display units 850, 860, 870 and 880 include a curved display region having a curved shape.

When the icon moves on the curved display region, the control unit may generate the moving effect of the icon according to the curved shape of the curved display region. The moving effect of icon may be to change at least one of a speed, a size and a shape of an icon. For example, while the icon moves on the curved display region of a waveform shape, the icon may move slower, and the shape of the icon may be changed according to the waveform.

As described above, a mobile device according to at least one exemplary embodiment of the inventive concept may have a three-dimensional structure including not only the first main display unit 830 but also the second main display unit 840 and the secondary display units 850, 860, 870, and 880, and may provide a user interface that implements the moving effect of the icon, thereby providing a user convenience and a pleasing visual effect. Further, in an exemplary embodiment of the inventive concept, the mobile device 100 may have the curved display region, which may result in an improvement in gripping the device.

In an exemplary embodiment, any one of the above described secondary display units (e.g., 160, 170, 180, etc) may be disposed in the same plane as the plane that the main display unit (e.g., 140) is disposed within. For example, the angle between the plane of one or more of the secondary display units may be zero or substantially zero with respect the plane of the main display unit. In an exemplary embodiment, one or more of the second display units may be omitted. In an exemplary embodiment, when one of the second display units is omitted, a physical keyboard may be disposed in the remaining space.

The present exemplary embodiments may be applied to any display device, and to any mobile device including the display device. For example, the present exemplary embodiments may be applied to a mobile device, such as a mobile phone, a smart phone, a laptop computer, a tablet computer, a personal digital assistants (PDA), a portable multimedia player (PMP), a digital camera, a music player, a portable game console, a navigation device, a watch, etc.

The foregoing is illustrative of exemplary embodiments of the inventive concept, and is not to be construed as limiting thereof. Although a few exemplary embodiments have been described, many modifications are possible in the exemplary embodiments without materially departing from the inventive concept. Accordingly, all such modifications are intended to be included within the scope of the inventive concept.

What is claimed is:

1. A mobile device comprising a flexible display device, the flexible display device comprising:
a main display unit disposed on a front of the mobile device along a plane;
an upper secondary display unit disposed on an upper side of the main display unit, the upper secondary display unit inclined at a first predetermined angle with respect to the plane;
a lower secondary display unit disposed on a lower side of the main display unit, the lower secondary display unit inclined at a second predetermined angle with respect to the plane;
a left secondary display unit disposed on a left side of the main display unit, the left secondary display unit inclined at a third predetermined angle with respect to the plane;
a right secondary display unit disposed on a right side of the main display unit, the right secondary display unit inclined at a fourth predetermined angle with respect to the plane; and
a control unit configured to control the flexible display device to change an icon when the icon displayed on one of the upper, lower, left, and right secondary display units passes a border of the one of the upper, lower, left, and right secondary display units.

2. The mobile device of claim 1, wherein the change is at least one of a change in size of the icon, a shape of the icon, and a speed at which the icon moves.

3. The mobile device of claim 1, wherein the main display unit and the upper, lower, left, and right secondary display units are integrally formed as one cross-shaped display panel.

4. The mobile device of claim 1, wherein the first through fourth predetermined angles between the plane and the upper, lower, left, and right secondary display units are acute angles.

5. The mobile device of claim 1, wherein at least one of the upper, lower, left, and right secondary display units are configured to be deactivated by a user setting.

6. The mobile device of claim 1, wherein the control unit performs one of a move command, a copy command, a deletion command, and a run command for the icon depending on a direction in which the icon moves.

7. The mobile device of claim 1, wherein, when the icon displayed on one of the upper, lower, left, and right secondary display units is moved to another one of the upper, lower, left, and right secondary display units by a drag and drop operation, the control unit performs one of a move command and a copy command for the icon.

8. The mobile device of claim 1, wherein, when the icon displayed on one of the upper, lower, left, and right secondary display units is moved out of the flexible display device by a drag and drop operation, the control unit performs a deletion command for the icon.

9. The mobile device of claim 1, wherein, when the icon displayed on one of the upper, lower, left, and right secondary display units moves to the main display unit, the control unit performs a run command for the icon to execute an application corresponding to the icon and to display an execution screen of the application on the main display unit, and
wherein, when the execution screen of the application moves to one of the upper, lower, left, and right secondary display units, the control unit terminates the executed application.

10. The mobile device of claim 1, wherein at least one of the main display unit, the upper secondary display unit, the lower secondary display unit, the left secondary display unit, and the right secondary display unit comprises a curved display region having a curved shape.

11. The mobile device of claim 10, wherein, while the icon moves on the curved display region, at least one of a speed, size, and a shape of the icon changes according to the curved shape of the curved display region.

12. A mobile device comprising a flexible display device, the flexible display device comprising:
a first main display unit disposed on a front of the mobile device along a first plane;
an upper secondary display unit disposed on an upper side of the first main display unit, the upper secondary display unit inclined at a first predetermined angle with respect to the first plane;
a lower secondary display unit disposed on a lower side of the first main display unit, the lower secondary display unit inclined at a second predetermined angle with respect to the first plane;
a second main display unit disposed on a back of the mobile device along a second plane;
a left secondary display unit disposed on a left side of the second main display unit, the left secondary display unit inclined at a third predetermined angle with respect to the second plane;
a right secondary display unit disposed on a right side of the second main display unit, the right secondary display unit inclined at a fourth predetermined angle with respect to the second plane; and
a control unit configured to control the flexible display device to change an icon when the icon displayed on one of the upper, lower, left, and right secondary display units passes a border of the one of the upper, lower, left, and right secondary display units.

13. The mobile device of claim 12, wherein the change is at least one of a change in size of the icon, a shape of the icon, and a speed at which the icon moves.

14. The mobile device of claim 12, wherein the first main display unit, the upper secondary display unit, and the lower secondary display unit are integrally formed as a first display panel, and
wherein the second main display unit, the left secondary display unit, and the right secondary display unit are integrally formed as a second display panel.

15. The mobile device of claim 12, wherein the first and second predetermined angles between the first plane and the upper and lower secondary display units are acute angles.

16. The mobile device of claim 12, wherein the third and fourth predetermined angles between the second plane and the left and right secondary display units are obtuse angles.

17. The mobile device of claim 12, wherein at least one of the upper, lower, left, and right secondary display units are configured to be deactivated by a user setting.

18. The mobile device of claim 12, wherein at least one of the first and second main display units are configured to be deactivated by a user setting.

19. The mobile device of claim 12, wherein at least one of the first main display unit, the second main display unit, the upper secondary display unit, the lower secondary display unit, the left secondary display unit, and the right secondary display unit comprises a curved display region having a curved shape.

20. The mobile device of claim 19, wherein, while the icon moves on the curved display region, at least one of a speed, a size, and a shape of the icon changes according to the curved shape of the curved display region.

21. A mobile device comprising a flexible display device, the flexible display device comprising:
a main display unit disposed on a front of the mobile device along a plane;
an upper secondary display unit disposed at an upper side of the main display unit, the upper secondary display unit inclined at a first predetermined angle with respect to the plane;
a lower secondary display unit disposed at a lower side of the main display unit, the lower secondary display unit inclined at a second predetermined angle with respect to the plane;
a left secondary display unit disposed at a left side of the main display unit, the left secondary display unit inclined at a third predetermined angle with respect to the plane;
a right secondary display unit disposed at a right side of the main display unit, the right secondary display unit inclined at a fourth predetermined angle with respect to the plane; and
a control unit configured to perform one of a move command and a copy command when an icon is moved from a first one of the secondary display units to another second one of the secondary display units.

22. The mobile device of claim 21, wherein the control unit presents a menu on the second one of the secondary display units that enables a user to select between one of the copy command and the move command.

23. The mobile device of claim 21, wherein the control unit is configured to change an appearance of the icon when the icon is moved outside the first secondary display unit.
